(19) United States
(12) Patent Application Publication
(10) Pub. No.: US 2002/0173912 A1
(43) Pub. Date: Nov. 21, 2002

(54) Internet-based well bore mapping system and method

(76) Inventor: Foy Streetman, Chickasha, OK (US)

Correspondence Address: R. William Graham, 3340 Rosewood Lane, Oklahoma City, OK, 73120, US

(21) Appl. No.: 09/859,949

(22) Filed: May 17, 2001

(51) Int. Cl. G06F 19/00

(52) U.S. Cl. 702/6

(57) ABSTRACT

An Internet-based well data mapping system includes a web-based server computer operably associated with the Internet having an operating system, a processor, a memory, a well data file for receiving well information data and a predetermined well equipment graphic data file template with predetermined well information data fields associated therewith. Well information data mapping software is operably associated with the web-based server computer for interactively displaying at least a portion of the well information data in one of the data fields of the well equipment graphic data file template over the Internet.

### BACKGROUND OF THE INVENTION

1. Field of the Invention

The present invention relates generally to the oil and gas industry More particularly, but not by way of limitation, the invention relates to an Internet-based well data mapping system and method of use in the oil and gas industry.

2. Related Art

In the field of oil and gas recovery, there is a well established need for well data information. Such information includes, but is not limited to well ownership, contact information, location, pipeline pressure, meter tube size, gas production (MCFD), water production (BWD), porosity, tubing size, orifice plate size, oil production, (BOPD), producing formation, permeability (MD), perf depths, tubing depth, flowing tubing pressure, shut in tubing pressure, packer, packer depth, seating nipple, casing size, flowing casing pressure, and shut in casing pressure. For production equipment information, such as production unit type, separator pressure rating, secondary coil size, secondary coil pressure rating, dump valve trim size, separator size, and sales line size are desirably needed information. Other information about low and high pressure separators, flow line size, dump valve size, dump valve type, sales line size dehydrators, tower size, tower configuration (tray/packed) and inlet scrubber are also needed information. Some of the information is static pertaining to a well and other information is not.

Such information is typically used by the oil and gas shopper in order to make an evaluation of the well, such as a determination whether to obtain an interest in the well. Still there exists other information of which amounts to a considerable amount to be reviewed about the prospective well or wells for the purchaser thus making the task difficult.

Currently, this well information is obtained though a wide variety of media, including paper and paperless forms and its components. This information remains not readily obtainable, and there has yet to exist a system to receive and/or present such information in a dynamic manner.

Once the core data is assembled, it is not easily understood without a pictoral representation of the well. A new picture is typically required to be created each time the well is reviewed. To date, no good vehicle exists which assembles the information in a manner which eases review and understanding by the prospective purchaser.

In this vein, there remains a need to place this oil and gas information in a format which is easily disseminated, usable and archivable by any prospective purchaser/seller. The present invention solves this need.

### BRIEF SUMMARY OF THE INVENTION

It is an object to provide an Internet-based well data mapping system and method of use thereof.

It is another object to ease the process in which oil and gas well information is disseminated for review by a prospective purchaser.

It is a further object to provide an Internet-based archivable well information database.

Accordingly, the present invention is directed to an Internet-based well data mapping system. The system includes a web-based server computer operably associated with the Internet having an operating system, a processor, a memory, a well data file for receiving well information data and a predetermined well equipment graphic data file template with predetermined well information data fields associated therewith. Well information data mapping software is operably associated with the web-based server computer for interactively displaying at least a portion of the well information data in one of the data fields of the well equipment graphic data file template over the Internet. The invention permits the well information data and the predetermined data fields to be revised over the Internet. The software provides for creation of an archived well data file. The well information data mapping software enables storage and retrieval of the archived well data in a manner to enable mapping to a corresponding well. Further, the invention provides for real time display of well information data through a remote transmission unit at the well site to the web based server computer.

Other objects and advantages will be readily apparent to those skilled in the art upon viewing the drawings and reading the detailed description hereafter.

### BRIEF DESCRIPTION OF THE DRAWINGS

FIG. 1 is a schematic view of the present invention.

FIG. 2 represents a well directory.

FIG. 3. represents selected well information data file from the well directory.

FIG. 4a represents a well information data file template.

FIG. 4b represents another part of the well information data file template.

FIG. 5a represents a completed template of FIG. 4a.

FIG. 5b represents a completed template of FIG. 4b.

FIG. 6 represents a well bore graphic information template having selected well bore information of FIG. 4b and FIG. 5b shown therein.

FIG. 7 represents another well diagram graphic information data file template.

FIG. 8a represents a well separator graphic information data file template having no well data information displayed thereon.

FIG. 8b represents low pressure separator data file with no data information therein.

FIG. 8c represents a well separator graphic information data file template having well data information displayed thereon.

FIG. 8d represents low pressure separator data file of FIG. 3.

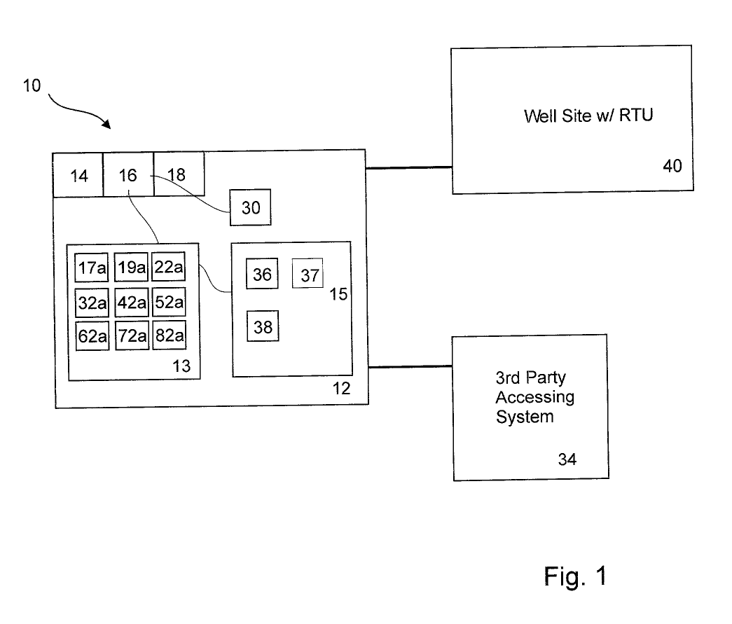

### DETAILED DESCRIPTION OF THE INVENTION

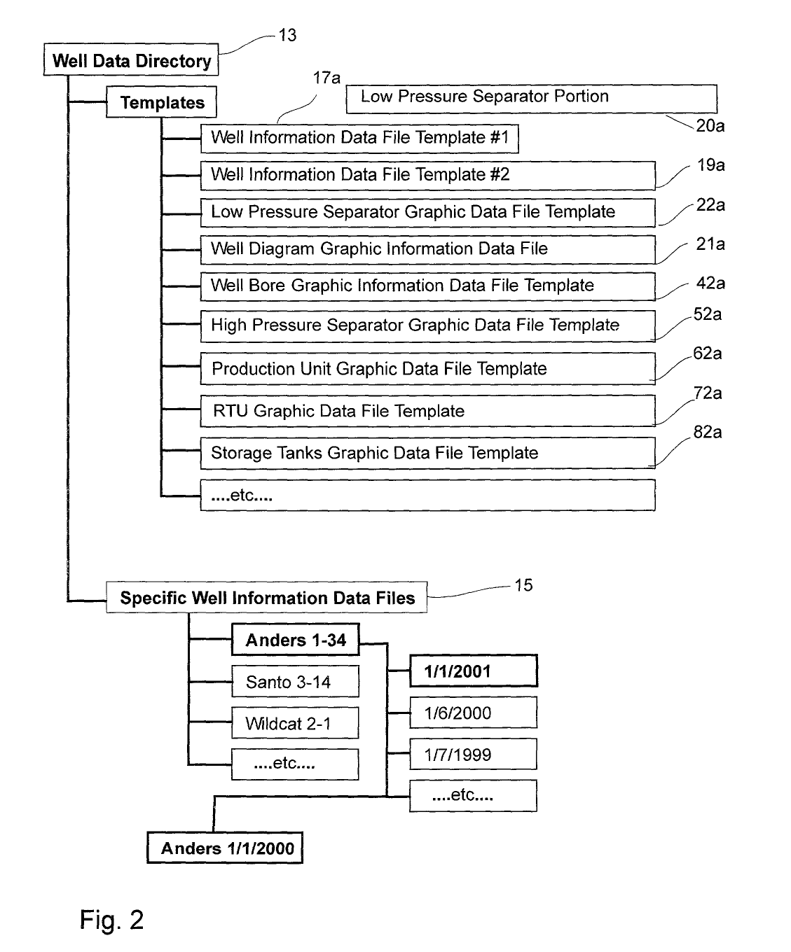

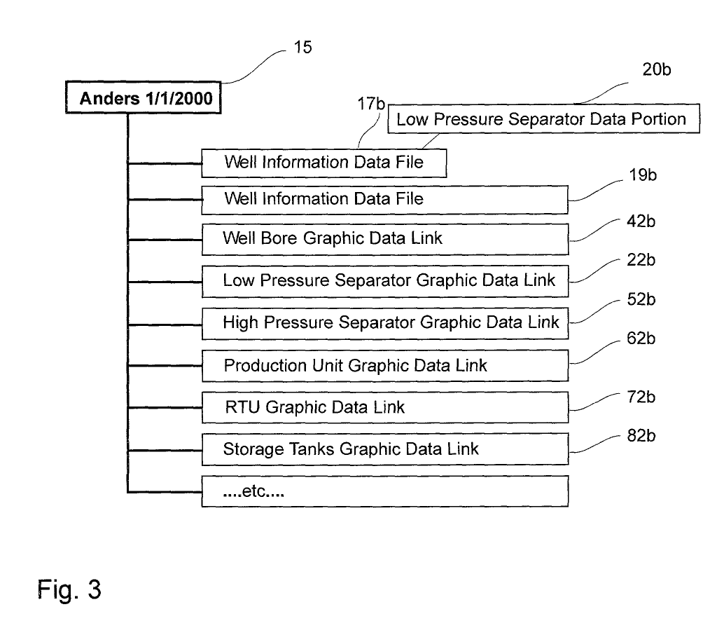

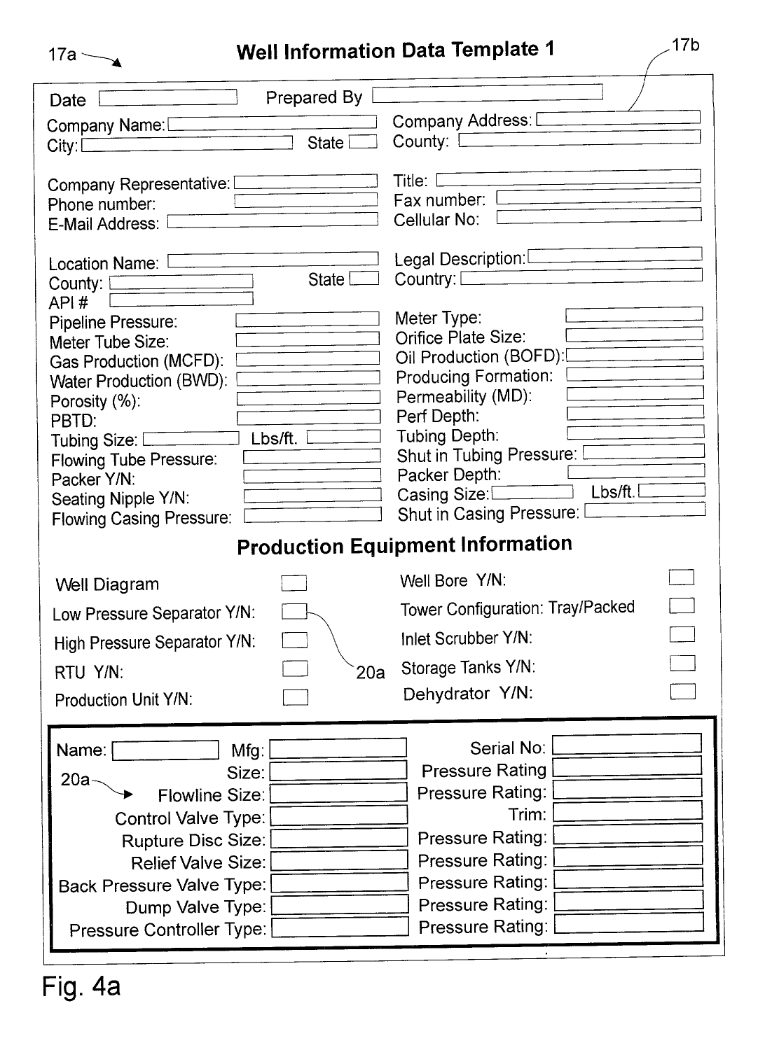

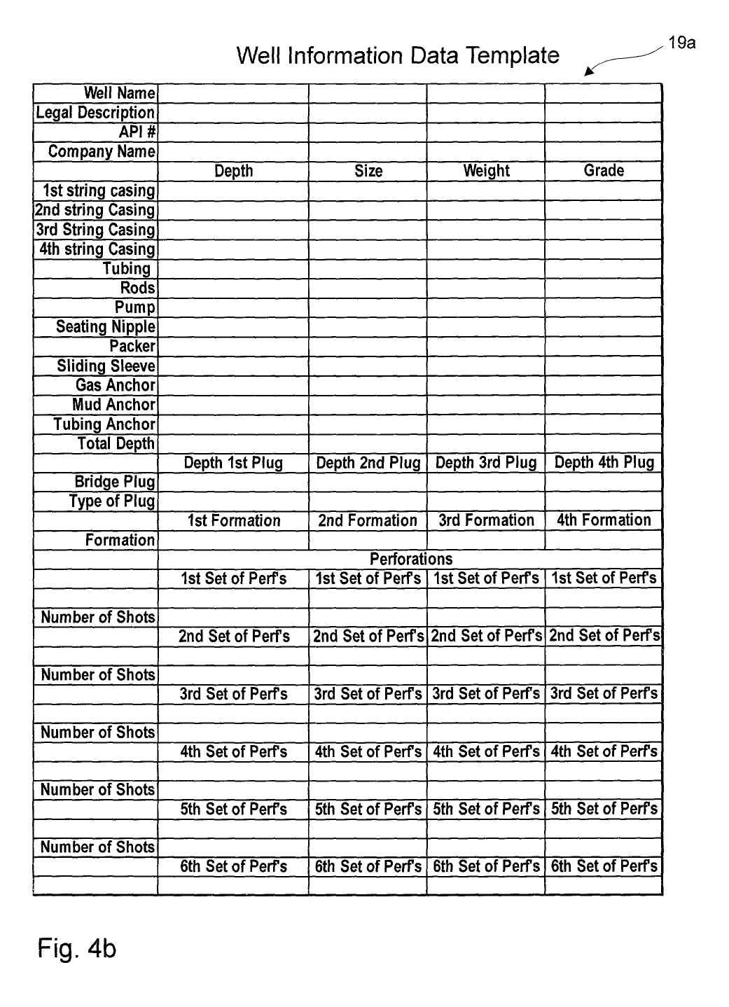

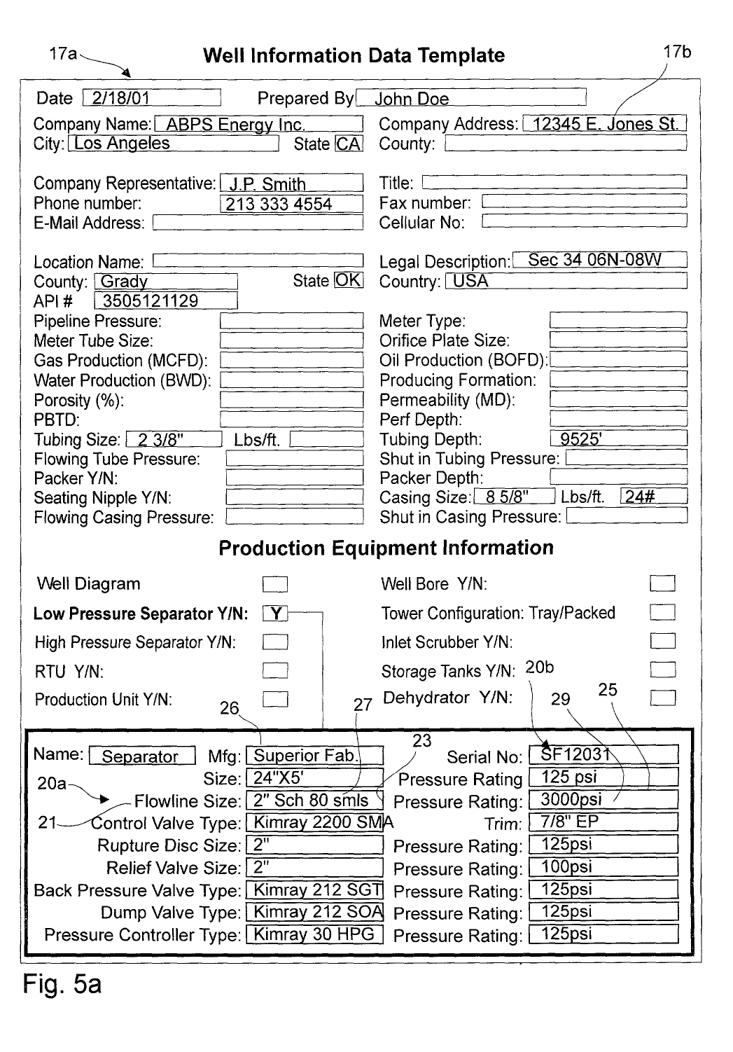

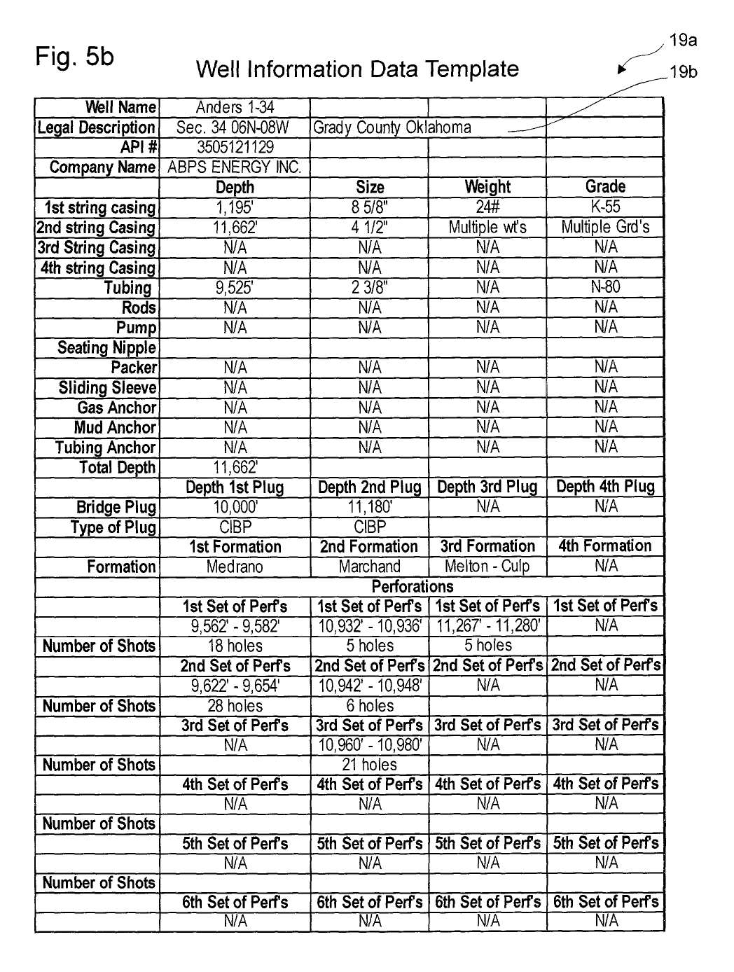

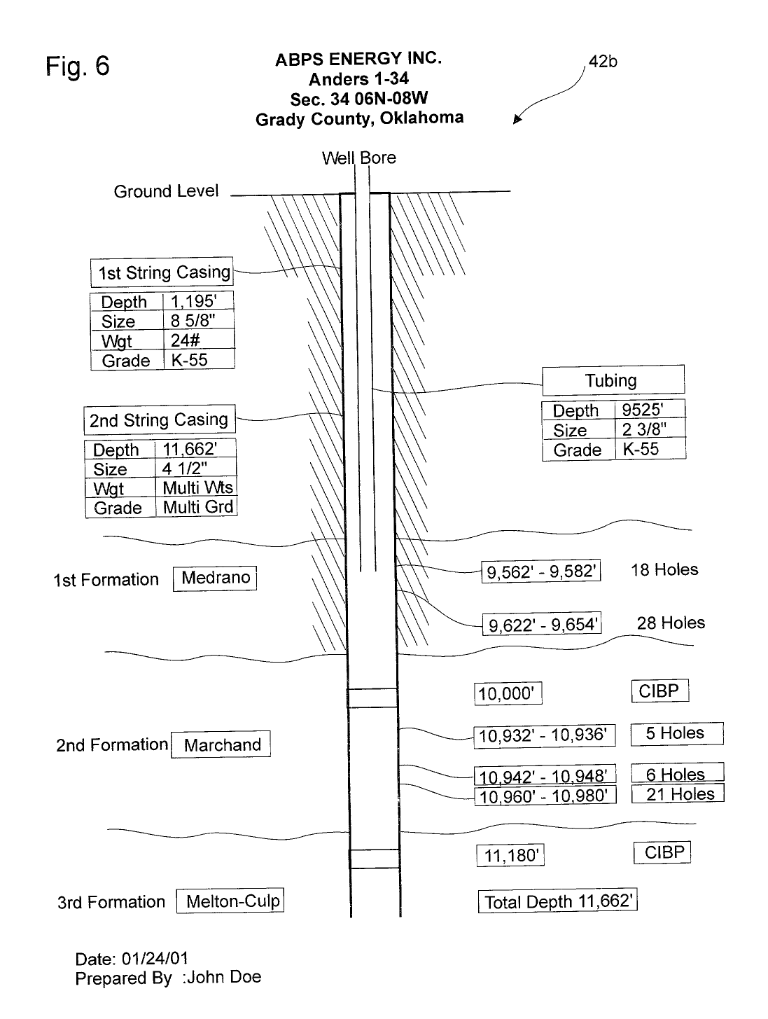

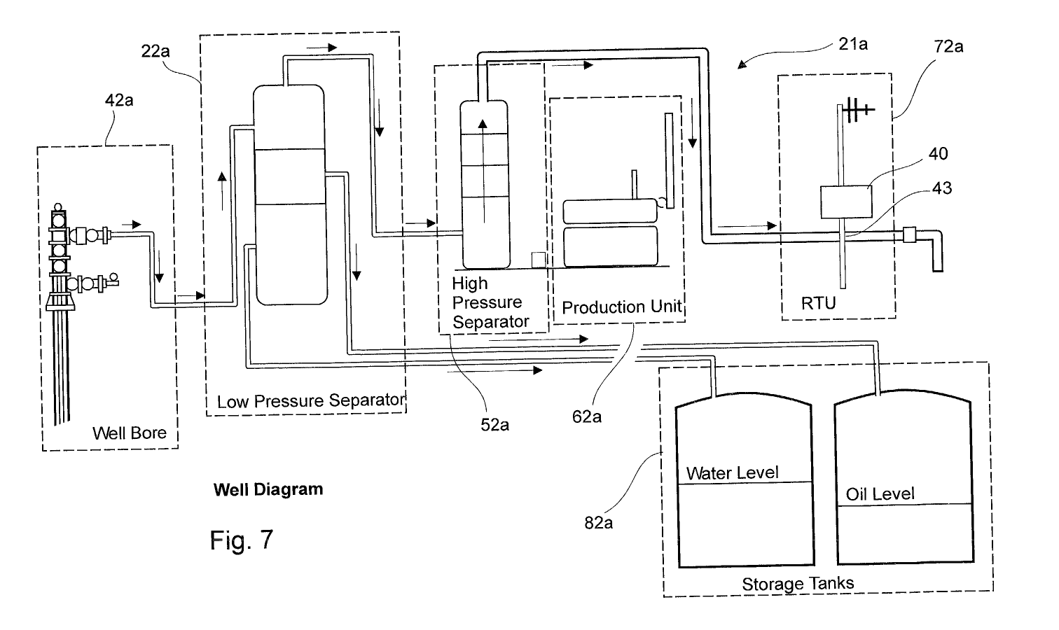

Referring now to the present invention, the Internet-based well bore data mapping system is generally referred to by the numeral 10. The system 10 includes a web-based server computer 12 operably associated with the Internet and has an operating system 14, a memory 16 and a processor 18. A well directory 13 resides in a part of the memory 16 which can preferably include well information data files 15 (FIG. 2), for example, or a number thereof each corresponding to specific wells, here identified as the Anders 1-34, Santo 3-14 and Wildcat 2-1 wells each of which include specific well data information as specified hereinafter. In the well directory 13, there are shown, for example, well information data file templates 17a (FIGS. 2 and 4a) and 19a (FIGS. 2 and 4b), well diagram graphic information data file template 21 a (FIG. 7), a low pressure well separator graphic data file template 22a, a well bore graphic data file template 42a, a high pressure separator graphic data file template 52a, a production unit graphic data file template 62a, RTU graphic data file template 72a, and a storage tanks graphic data file template 82a. As seen in FIG. 3, each file 15 can include such information as, well information data files 17b (FIGS. 3 and 5a) and 19b (FIGS. 3 and 5b), a low pressure well separator data link 22b, a well diagram information data link 32b, a well bore graphic information data link 42b, a high pressure separator graphic information data link 52b, a production unit graphic information data link 62b, an RTU data link 72b, and a storage tank graphic information data link 82b.

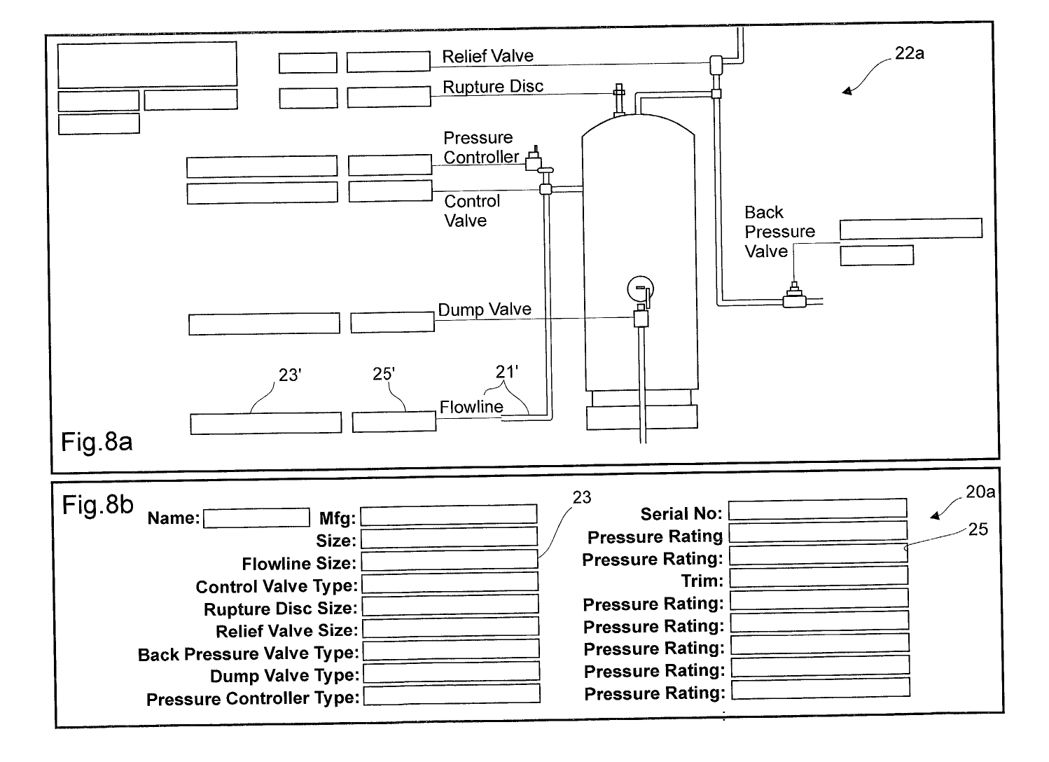

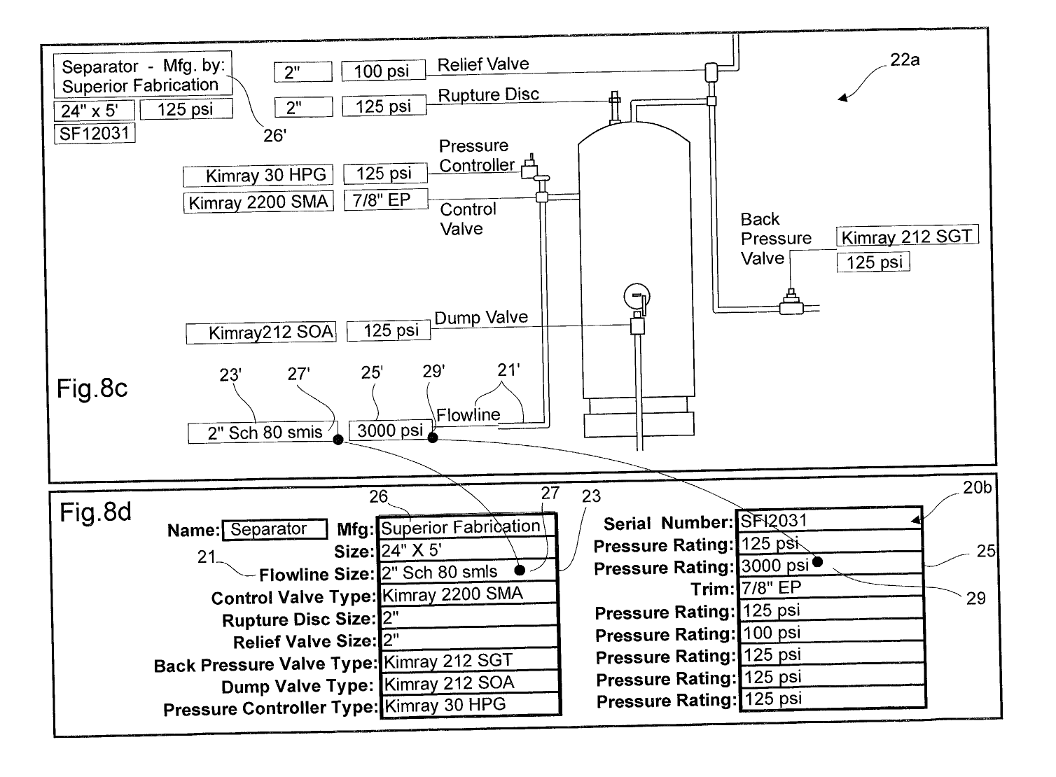

The well information data file templates 17a and 19a are shown in blank in FIGS. 4a and 4b, respectively, whereas the well information data file information 17b and 19b shown in FIGS. 5a and 5b, respectively, include information data input shown in the templates 17a and 19a. FIG. 7 shows the well diagram graphic information template which includes other graphic templates previously recited. Well mapping Software 30 described herein provides for selecting one portion of the template, for example, which can obtain corresponding data information through a respective data link in order to display the corresponding information with the selected template portion. FIG. 8a represents the low pressure separator graphic information data file template 22a. which is disposed adjacent a portion 20a (FIG. 8b) of well information data file template 17a seen in FIG. 4a. As seen in FIGS. 8c and 8d, the particular fields 23 and 25, and 23′ and 25′, for example, shown in a portion 20b of well information data file template 17b seen in FIG. 5a, are linked in which well information data 27 and 29, are displayed as 27′ and 29′, respectively, into the fields 23′ and 25′ adjacent low pressure separator graphic data file 22a as shown in FIG. 8d. This occurs through well mapping software 30 being operably associated with CPU 12 to enable such information data 27 and 29 to be input into the templates 17a and 19a and stored in data files 17b and 19b, for subsequent retrieval and provide for automatically importing data 27 and 29 into the field 23 and 25 and/or the fields 23′ and 25′ which is shown as data 27′ and 29′ into template 22a. Again, upon accessing the low pressure well separator graphic data link 22b initiates exporting of corresponding information from the well data file 17b as portion 20b in FIG. 5a and displays the same in template 22a as shown in FIG. 8c. This is schema is set forth to exemplify how the data is stored in and retrieved from the data files 17b and 19b and represented on the various templates and is not intended to be limiting to those described herein.

The low pressure separator graphic data link 22b can preferably include well information data 21′ represented textually and/or pictorally, for example, in FIG. 8c which corresponds to well information data 21 in portion 20a. Such well information data can include, but is not limited to, such informational data as well ownership, contact information, location, equipment specification and type, e.g., separator, serial no., size, flow line size, control valve type, rupture disc size, relief valve size, back pressure valve type, dump valve type, pressure controller type, and pressure rating for each part. Further, information can be supplied relating to pipeline pressure, meter tube size, gas production (MCFD), water production (BWD), porosity, tubing size, orifice plate size, oil production, (BOPD), producing formation, permeability (MD), perf depths, tubing depth, flowing tubing pressure, shut in tubing pressure, packer, packer depth, seating nipple, casing size, flowing casing pressure, and shut in casing pressure, production equipment information, such as production unit type, separator pressure rating, secondary coil size, secondary coil pressure rating, dump valve trim size, separator size, and sales line size is typically utilized, low pressure separator existence, flow line size, dump valve size, dump valve type is utilized, high pressure separator information uses flow line size, sales line size and dump valve trim size, and a dehydrator existence, tower size, tower configuration (tray/packed) and inlet scrubber information; and tubing weight size type and length, down hole tools such as backers seal-assembles no-goes production devises etc., casing weight size type and length, surface pipe weight size type and depth, wellhead assembly, valve sizes, zones perforated, zones behind pipe, rod size and depth, pump size and type, and other such information. Information such as depth, size, weight and grade relating to casing, tubing, rods, pump, seating nipple, packer, sliding sleeve, anchors, type plugs, type formations, perforations and number of shots therein are gatherable.

It should be noted that the database well data mapping software 30 provides for interactively displaying such exemplary well data 27, 29, and 27′, 29′ in the predetermined data fields 23, 25 and 23′, 25′, respectively, over the Internet and permitting at least one of the predetermined data fields to be viewed, revised or updated over the Internet by a remote client computer 34 to create a date specific well data file 36 as seen in FIG. 3. Archived data files 37, 38, etc. represent earlier created files. The well mapping software 30 enables storage and retrieval of the archived date specific well data files 36, 37 and 38 in an archived data file directory 38 to and from the directory 15.

Further, the software 30 provides for recognizing a GET REQUEST for one of well data files 36-38, for example, and generates an authorization data field to be displayed, whereupon entry of predetermined authorization data there into, the GET REQUEST is performed. In other words, the files are thus access protected. Upon access, the mapping software 30 enables editing thereof and saving as another date specific data file. The mapping software 30 can enable retrieval and viewing of an archived well data file to an unauthorized party, if so desired.

A remote transmitting unit (RTU) 40 is also preferably provided as shown in FIG. 7. Here, the RTU 40 can directly transmit information via WAP technology or land line, for example, and thus continuously produce a real time display of well information data such as pipeline pressure 43 to provide an active real time link which can be periodically automatically archived as part of a data file by the software 30. The mapping software 30 can be used for well operations, for sending and receiving data for commands to re-set equipment, flow rates, pump speeds, and or use to determine such settings based on conditions so monitored. In this way, a remotely located user such as an engineer or field operator, can access the system 10 and use the information to perform operations on the well.

It is also contemplated that the templates 17a and 19a can have or enable creation of other fields to fill out for surface-equipment whereby the database well mapping software 30 is equipped to store data in data files 17b and 19b, and have or enable creation of data links which upon selecting permits the stored data into an existing or created surface-equipment well equipment graphic data template. In this regard, the software can permit display of various layouts of sizes, models, and configurations of the production equipment being used on the surface, and show all the equipment connected together with valve sizes etc., based upon the input data. The present invention can thus provide a web-site with all the field well-site data online where it can better serve the customer by hosting and serving this information to other supply and services companies, for the well operators.

The above described embodiments is set forth by way of example and is not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

What is claimed is:

1. An Internet-based well data mapping system for use in aiding evaluation of an oil and gas well over an Internet, which includes:
a web-based server computer operably associated with the Internet having an operating system, a memory and a processor, a well data file for receiving well information data and a predetermined well equipment graphic data file template with predetermined data fields associated therewith in said memory, data base well data mapping software operably associated with said web-based server computer for displaying at least a portion of said well information data in said data field along with said well equipment graphic data file template over the Internet.

2. The Internet-based well data mapping system of claim 1, wherein said software permits at least one of said well information data to be revised over the Internet to create an archived well data file, said software enabling storage and retrieval of said archived well data file.

3. The Internet-based well data mapping system of claim 1, whereupon retrieval of said archived well data file, said software enables editing thereof to create a second archived well data file with storage and retrieval thereof.

4. The Internet-based well data mapping system of claim 2, wherein said database well data mapping software recognizes a GET REQUEST for said archived data file and generates an authorization data field to be displayed, whereupon entry of predetermined authorization data there into said GET REQUEST is performed.

5. The Internet-based well data mapping system of claim 4, wherein said mapping software enables editing of said archived well data file to an authorized party.

6. The Internet-based well data mapping system of claim 1, wherein said mapping software enables retrieval and viewing of said archived well data file to an unauthorized party.

7. A method of performing Internet-based well data mapping over an Internet, which includes:
employing a web-based server computer operably associated with the Internet having an operating system, a memory and a processor, a well data file for receiving well information data and a predetermined well equipment graphic data file template with predetermined data fields associated therewith, data base well data mapping software operably associated with said web-based server computer for displaying said well information data in said predetermined data fields along with said well equipment graphic template data over the Internet; and
accessing said web-based server computer over the Internet from a remote site to view said archived said well information data in said predetermined data fields along with said well equipment graphic template data.

8. The method of the invention in accordance with claim 7, which further includes accessing said archived well information data and revising over the Internet to create an second archived well data file which can be stored and retrieved.

9. The Internet-based well data mapping system of claim 7, which includes using said software for recognizing a GET REQUEST for said archived data file and generating an authorization data field to be displayed, whereupon entry of predetermined authorization data there into, said GET REQUEST is performed.

10. The Internet-based well data mapping system of claim 4, wherein said mapping software enables editing of said archived well data file to an authorized party.
